(19) United States
(12) Patent Application Publication
(10) Pub. No.: US 2026/0183084 A1
(43) Pub. Date: Jul. 2, 2026

(54) ELASTIC SHEET FOR DENTISTRY AND DEVICES AND METHODS FOR MAKING AND USING THE SAME

(71) Applicant: Fernando J. Meza, Alexandria, VA (US)

(72) Inventor: Fernando J. Meza, Alexandria, VA (US)

(21) Appl. No.: 19/006,827

(22) Filed: Dec. 31, 2024

(51) Int. Cl. A61C 5/82; B26F 1/14

(52) U.S. Cl. CPC A61C 5/82; B26F 1/14

(57) ABSTRACT

An elastic sheet for dentistry with a working portion and a breathing portion comprising a perforated region having a plurality of perforations, each of the plurality of perforations having an open surface area sized to provide breathability to the elastic sheet while simultaneously preventing, e.g., dental tools, debris, water, and/or saliva from falling therein.

### TECHNICAL FIELD

The present disclosure relates to an elastic sheet for dentistry. In particular, the present disclosure relates to perforated elastic sheets for density.

### BACKGROUND

Because dental procedures are performed adjacent to patients' airways, there is an inherent risk that dental tools and/or debris (e.g., tooth filings) may fall into patients' airways during dental procedures. Similarly, because dental procedures are also performed adjacent to other sensitive anatomical structures (e.g., the tongue, lips, gingiva, and adjacent teeth), there is also a risk that dental tools may inadvertently injure these anatomical structures during said procedures. Dentistry may also be complicated by the fact that a patient's saliva may undesirably wet an area to be treated.

Some solutions attempt to cure the aforementioned issues. For example, an opening may be cut into an elastic sheet, attached to a tooth of a patient, and spread about the patient's mouth so that the elastic sheet functions as a barrier isolating the tooth-to-be-treated—thereby preventing dental tools and/or debris from falling into the patient's airway or otherwise injuring adjacent anatomic structures. These solutions may also prevent the patient's saliva from wetting the area isolated by the sheet.

These solutions, however, suffer from a variety of deficiencies. For example, because the elastic sheets of these solutions are spread about patients' mouths, patients may feel as their breathing is restricted, which could potentially induce a claustrophobic sensation. (See, e.g., Mackenzie et al., Splendid Isolation: A Practical Guide to the Use of Rubber Dam Part 1, 47 DENTAL UPDATE 548-58 (July 2020).)

These deficiencies have led to many dentists failing to adopt the aforementioned solutions. A 2013 study, for example, revealed that, even for root canal treatments—where elastic sheets for are highly recommended to prevent ingestion or aspiration of tooth filings—U.S.-based dentists failed to use an elastic sheet in more than 50% of cases. (Anabtawi et al., Rubber Dam Use During Root Canal Treatment: Findings from the Dental Practice-Based Research Network, 144 J. AM. DENTAL ASSOC. 179-86 (2013).) Similarly, a 2014 study in India revealed that, despite the fact that 94% of surveyed dentists were aware of elastic sheets for dentistry, only 23% of said dentists utilized elastic sheets during root canals. (Shashirekha et al., Prevalence of Rubber Dam Usage During Endodontic Procedure: A Questionnaire Survey, 8 J. CLINICAL & DIAGNOSTIC RSCH. 1-3 (2014).) In Taiwan, elastic sheet usage is even less prevalent, with a 2011 study reporting that dentists utilized elastic sheets in only 16% of root canal treatments. (Lin et al., Use of Rubber Dams During Root Canal Treatment in Taiwan, 110 J. FORMOSAN MED. ASSOC. 397-400 (2011).)

In daily practice, a 2018 study reveals that, overall, dentists utilize elastic sheets in only about 24% of cases, (Sanghvi et al., A Cross Sectional Study on Frequency of Rubber Dam Usage Among Dentists Practicing in Maharashtra, India, 8 SAUDI ENDODONTIC J. 1-6 (2018)), with most developed countries exhibiting a usage rate ranging anywhere from 2% to 38%. (Id.) Swedish dentists, who exhibit the highest usage rates of elastic sheets, still only use elastic sheets in about 67% of cases. (Koch et al., Effect of Educational Intervention on Adoption of New Endodontic Technology by General Dental Practitioners: A Questionnaire Survey, 42 INT'L ENDODONTIC J. 313-21 (2009).)

Given an expected increase in the amount of root canals to be performed worldwide, and a general increase in oral health awareness worldwide, there is a present and ongoing need for an elastic sheet that provides a solution to the above-described issues so that these future procedures may be performed more safely.

It is therefore a goal of the present disclosure to provide solutions to the above-described issues so that the use of elastic sheets may become more prominent in dentistry.

### SUMMARY

The present disclosure describes an elastic sheet for dentistry comprising a plurality of perforations sized to provide breathability to the elastic sheet and simultaneously sized to prevent, e.g., dental tools, debris, water, and/or saliva from falling therein.

The present disclosure also describes a punch comprising a plurality of protrusions configured to perforate an elastic sheet to be used for dentistry.

The foregoing and other objects, features, and advantages of the present description will become more apparent from the following detailed description, which proceeds with reference to the accompanying figures.

A first embodiment (I) of the present disclosure is directed towards an elastic sheet for dentistry comprising a working portion and a breathing portion comprising a perforated region, the perforated region comprising a plurality of perforations, wherein each of the plurality of perforations comprises an open surface area ranging from 0.12 mm² to 1.2 mm² when the elastic sheet is in an unstretched state, wherein each of the plurality of perforations comprises at least 50 perforations, and wherein the elastic sheet is sized to be removably coupled to a frame for dentistry.

In a second embodiment (II), the breathing portion according to the first embodiment (I) comprises a plurality of perforated regions and each of the plurality of perforated regions comprises a subset of the plurality of perforations.

In a third embodiment (III), each of the subsets of the plurality of perforations according to the second embodiment (II) comprises at least 50 perforations.

In a fourth embodiment (IV), a surface area of the breathing portion according to any one of embodiments (I)-(III) ranges from 40% to 60% of a total surface area of the elastic sheet.

In a fifth embodiment (V), a center-to-center distance of each of the plurality of perforations according to any one of embodiments (I)-(IV) ranges from 1 mm to 6 mm when the elastic sheet is in the unstretched state, the center-to-center distance measured from a first geometric center of a first perforation to a second geometric center of a second perforation, the second perforation being immediately adjacent to the first perforation.

In a sixth embodiment (VI), the center-to-center distance of each of the plurality of perforations according to embodiment (V) ranges from 2.8 mm to 4.2 mm when the elastic sheet is in the unstretched state.

In a seventh embodiment (VII), the plurality of perforations according to any one of embodiments (I)-(VI) comprises a cumulative open surface area ranging from 20 mm² to 90 mm² when the elastic sheet is in the unstretched state.

In an eighth embodiment (VIII), the plurality of perforations according to any one of embodiments (I)-(VII) comprises 80 to 190 perforations.

In a ninth embodiment (IX), the perforated region according to any one of embodiments (I) and (IV)-(VIII) comprises four quadrants and each of the four quadrants comprises at least 20 perforations.

In a tenth embodiment (X), the plurality of perforations according to any one of embodiments (I)-(IX) comprises concentric bands of perforations arranged about a geometric center of the perforated region.

In an eleventh embodiment (XI), a perimeter of a perforated region according to any one of embodiments (I)-(X) is defined by an outermost perimeter set of perforations of the plurality of perforations and an open area ratio of the perforated region ranges from 0.005 to 0.07 when the elastic sheet is in the unstretched state, the open area ratio being a sum of the open surface area of the perforations divided by a total surface area of the perforated region.

In a twelfth embodiment (XII), the plurality of perforations according to any one of embodiments (I)-(XI) comprises an open surface area ranging from 0.12 mm² to 0.29 mm² when the elastic sheet is in the unstretched state.

In a thirteenth embodiment (XIII), the working portion according to any one of embodiments (I)-(XII) comprises an opening configured to accept a tooth of a patient therein.

In a fourteenth embodiment (XIV), a perimeter of the perforated region according to any one of embodiments (I), (IV)-(XIII) is defined by an outermost perimeter set of perforations of the plurality of perforations and the perimeter ranges from 105 mm to 155 mm when the elastic sheet is in the unstretched state.

A fifteenth embodiment (XV) of the present disclosure is directed towards a method of using the elastic sheet according to any one of embodiments (I)-(XIV) comprising the steps of inserting a clamp into an opening in the working portion of the elastic sheet, attaching the clamp to a tooth of a patient, and removably coupling the elastic sheet to the frame for dentistry, wherein the elastic sheet at least partially covers a mouth of the patient when removably coupled to the frame for dentistry.

In a sixteenth embodiment (XVI), the elastic sheet according to the fifteenth embodiment (XV) is in a stretched state when removably coupled to the frame for dentistry and each of the plurality of perforations comprises an open surface area ranging from 0.12 mm² to 1.2 mm² when the elastic sheet is in the stretched state.

In a seventeenth embodiment (XVII), the plurality of perforations according to the fifteenth embodiment (XV) or the sixteenth embodiment (XVI) comprises a cumulative open surface area ranging from 20 mm² to 90 mm² when the elastic sheet is in the stretched state.

An eighteenth embodiment (XVIII) of the present disclosure is directed towards a punch for perforating an elastic sheet to be used for dentistry, the punch comprising a perforating member comprising a perforating region, the perforating region comprising a plurality of protrusions, and a base configured to receive the plurality of protrusions, wherein the punch is configured to perforate an elastic sheet placed between the base and the perforating member with a plurality of perforations, each of the plurality of perforations comprising an open surface area ranging from 0.12 mm² to 1.2 mm², and wherein the plurality of protrusions comprises at least 50 protrusions.

In a nineteenth embodiment (XIX), the plurality of protrusions according to the eighteenth embodiment (XVIII) comprises 80 to 190 protrusions.

In a twentieth embodiment (XX), a center-to-center distance of each of the plurality of protrusions according to the eighteenth embodiment (XVIII) or the nineteenth embodiment (XIX) ranges from 1 mm to 6 mm, the center-to-center distance being a distance measured from a first geometric center of a first protrusion to a second geometric center of a second protrusion, the second protrusion being immediately adjacent to the first protrusion.

### BRIEF DESCRIPTION OF THE FIGURES

Embodiments of the present disclosure will be described in more detail with reference to the following figures. Together with the description, the Figures further serve to explain the principles of and to enable a person skilled in the relevant art(s) to make and use the disclosed embodiments. These Figures are intended to be illustrative, not limiting. Although the disclosure is generally described in the context of these embodiments, it should be understood that it is not intended to limit the scope of the disclosure to these particular embodiments. In the Figures, like reference numbers indicate identical or functionally similar elements.

FIG. 1 shows an elastic sheet for dentistry according to some embodiments.

FIG. 2 shows an elastic sheet for dentistry according to some embodiments.

FIG. 3 shows an elastic sheet for dentistry according to some embodiments.

FIG. 4 shows an elastic sheet for dentistry according to some embodiments spread about a mouth of a patient.

FIG. 5 shows a method of using an elastic sheet for dentistry according to some embodiments.

FIGS. 6A-B show a punch for perforating an elastic sheet to be used for dentistry according to some embodiments.

### DETAILED DESCRIPTION

Various embodiments and aspects of the present disclosure will be described with reference to the details discussed below. The following description and drawings are illustrative of the present disclosure and are not to be construed as limiting the present disclosure. Numerous specific details are described to provide a thorough understanding of the various embodiments of the present disclosure. However, in certain instances, well-known or conventional details are not described in order to provide a concise discussion of the embodiments of the present disclosure.

The indefinite articles “a,” “an,” and “the” include plural referents unless clearly contradicted or the context clearly dictates otherwise.

The term “comprising” is an open-ended transitional phrase. A list of elements following the transitional phrase “comprising” is a non-exclusive list, such that elements in addition to those specifically recited in the list may also be present. The phrase “consisting essentially of” limits the composition of a component to the specified materials and those that do not materially affect the basic and novel characteristic(s) of the component. The phrase “consisting of” limits the composition of a component to the specified materials and excludes any material not specified.

Where a range of numerical values comprising upper and lower values is recited herein, unless otherwise stated in specific circumstances, the range is intended to include the endpoints thereof, and all integers and fractions within the range. It is not intended that the disclosure or claims be limited to the specific values recited when defining a range. Further, when an amount, concentration, or other value or parameter is given as a range, one or more ranges, or as list of upper values and lower values, this is to be understood as specifically disclosing all ranges formed from any pair of any upper range limit or value and any lower range limit or value, regardless of whether such pairs are separately disclosed.

In the context of dentistry, it may desirable to provide an elastic sheet with an opening, such that the opening may be coupled to a tooth of a patient and spread about the patient's mouth. The sheet spread about the patient's mouth can prevent tools and/or debris from falling into the patient's airway or otherwise injuring adjacent anatomic structures while also preventing the patient's saliva from seeping into the area isolated by the elastic sheet. However, simply spreading an elastic sheet about a patient's mouth in this manner may result in the patient feeling that their breathing is restricted.

Perforated elastic sheets according to the embodiments of the present application are configured to simultaneously allow a patient to breathe comfortably and prevent foreign material, e.g., dental tools, debris, water, and/or salvia from falling into a patient's airway. This is accomplished with a plurality of perforations sized and positioned as described herein such that, in the aggregate, the plurality of perforations provide a sufficient cumulative open surface area configured to provide breathability to the perforated elastic sheets. Simultaneously, in these embodiments, the plurality of perforations are also sized and positioned as described herein such that the individual open surface area of each of the plurality of perforations is small enough to prevent, e.g., dental tools, debris, water, and/or salvia from falling therein.

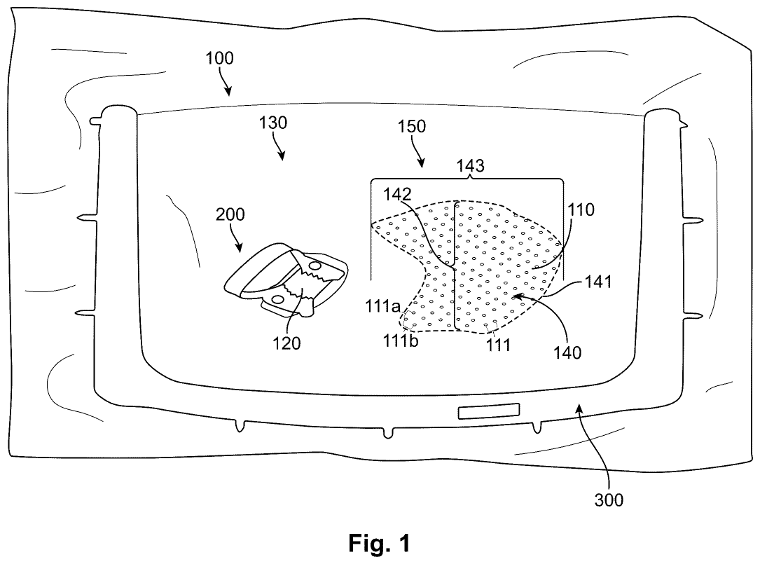

FIG. 1 shows an elastic sheet 100 for dentistry according to some embodiments. Elastic sheet 100 comprises a plurality of perforations 110 that provides breathability to elastic sheet 100, reducing patients' perception that their breathing is restricted when elastic sheet 100 is stretched about their mouths. Simultaneously, each of the plurality of perforations 110 are sized to prevent, e.g., dental tools, debris, water, and/or saliva from falling therein.

As shown, elastic sheet 100 may comprise a working portion 130 and a breathing portion 150. In some embodiments, a surface area of working portion may be approximately 50% of a total surface area of elastic sheet 100. In some embodiments, the surface area of working portion 130 may range from 40% to 60% of the total surface area of elastic sheet 100. Breathing portion 150 is adjacent to working portion 130. In some embodiments, a surface area of breathing portion 150 may be approximately 50% of a total surface area of elastic sheet 100. In some embodiments, the surface area of breathing portion may range from 40% to 60% of the total surface area of elastic sheet 100.

As shown, elastic sheet 100 is sized to be removably coupled to a frame for dentistry 300. Frame for dentistry 300 is configured to stretch elastic sheet 100 from an unstretched state to a stretched state such that elastic sheet 100 at least partially covers a mouth of a patient. Stretching of elastic sheet 100 to its stretched state prevents dental tools and/or debris from falling into an airway of the patient during dentistry. Exemplary elastic materials for elastic sheet 100 include, but are not limited to, latex, nitrile, polyurethane, neoprene, polyisoprene, and/or any combination thereof.

In some embodiments, elastic sheet 100 may have a width ranging from 120 mm to 180 mm. In some embodiments, elastic sheet 100 may have a width ranging from 100 mm to 150 mm. In some embodiments, elastic sheet 100 may have a height ranging from 120 mm to 180 mm. In some embodiments, elastic sheet 100 may have a height ranging from 100 mm to 150 mm. In some embodiments, elastic sheet 100 may have a thickness ranging from 0.1 mm to 0.3 mm.

In some embodiments, elastic sheet 100 may comprise an opening 120 in the working portion 130. In such embodiments, opening 120 is configured to accept a tooth of a patient therein so that, in advance of a dental procedure, elastic sheet 100 may be removably coupled to the tooth. Coupling elastic sheet 100 to the tooth via opening 120 may isolate the tooth from the rest of the patient's mouth, thereby preventing saliva from seeping into the area surrounding the tooth and protecting adjacent anatomic structures. In some embodiments, elastic sheet 100 may comprise more than one opening 120 so that multiple teeth can be isolated from the rest of the patient's mouth. In other embodiments, elastic sheet 100 does not comprise a pre-formed opening 120, thereby allowing a dentist to create their own, custom opening(s) 120 by, e.g., cutting elastic sheet 100.

In some embodiments, opening 120 is configured to accept a clamp 200 therein. In such embodiments, clamp 200 is configured to removably couple to a patient's tooth and, accordingly, elastic sheet 100 is removably coupled to the tooth by way of clamp 200. In embodiments with multiple openings 120, one or more of openings 120 may be configured to receive clamp 200 therein.

As mentioned above, elastic sheet 100 comprises a plurality of perforations 110 located in the breathing portion 150 that provides breathability to elastic sheet 100, reducing patients' perception that their breathing is restricted when elastic sheet 100 is stretched about their mouths. Simultaneously, each of the plurality of perforations 110 are sized to prevent, e.g., dental tools, debris, water, and/or saliva from falling therein.

In some embodiments, the plurality of perforations comprises at least 50 perforations. In some embodiments, the plurality of perforations comprises at least 60 perforations. In some embodiments, the plurality of perforations comprises at least 70 perforations. In some embodiments, the plurality of perforations comprises at least 90 perforations. In some embodiments, the plurality of perforations comprises 50 to 190 perforations. In some embodiments, the plurality of perforations comprises 60 to 190 perforations. In some embodiments, the plurality of perforations comprises 70 to 190 perforations. In some embodiments, the plurality of perforations comprises 80 to 190 perforations.

Each of the plurality of perforations 110 have an open surface area sized to provide breathability to elastic sheet 100 and to simultaneously prevent foreign material, e.g., dental tools, debris, water, and/or saliva from falling therein. The open surface area of each of the plurality of perforations 110 is designed to simultaneously provide breathability and block foreign material when elastic sheet 100 is not only in an unstretched state, but also in a stretched state (e.g., when elastic sheet 100 is removably coupled to frame for dentistry 300). Put otherwise, the open surface areas of the plurality of perforations 110 are sized such that, when elastic sheet 100 deforms as it is stretched from an unstretched state, the open surface areas of the plurality of perforations do not deform large enough so as to allow, e.g., dental tools, debris, water, and/or salvia to fall therein. As used here, the “unstretched state” for elastic sheet 100 is the state in which no tensile force (e.g., a force applied by frame for dentistry 300) is imparted on elastic sheet 100.

In some embodiments, the open surface area of each of the plurality of perforations 110 ranges from 0.12 mm² to 1.2 mm² when elastic sheet 100 is in an unstretched state. In some embodiments, the open surface area of each of the plurality of perforations 110 ranges from 0.12 mm² to 1.2 mm² when elastic sheet 100 is in a stretched state (e.g., when elastic sheet 100 is removably coupled to frame for dentistry 300). In some embodiments, the open surface area of each of the plurality of perforations 110 ranges from 0.12 mm² to 0.29 mm² when elastic sheet 100 is in an unstretched state. In some embodiments, the open surface area of each of the plurality of perforations 110 ranges from 0.12 mm² to 0.29 mm² when elastic sheet 100 is in a stretched state (e.g., when elastic sheet 100 is removably coupled to frame for dentistry 300). The open surface area of a perforation 110 is the size of the opening in the elastic sheet defined by the perforation 110.

In some embodiments, the open surface area of all or a portion of the plurality of perforations 110 may be circular when elastic sheet 100 is in an unstretched and/or stretched state. In some embodiments, the open surface area of all or a portion of the the plurality of perforations 110 may be crescent-shaped, ovular, or polygonal when elastic sheet 100 is in an unstretched and/or stretched state. The open surface areas of the plurality of perforations 110 may be any shape and/or combinations of shapes. By way of example, the open surface area of one perforation of plurality of perforations 110 may be circular while the open surface area of another perforation of plurality of perforations 110 may be polygonal.

Each of the plurality of perforations 110 may be spaced from one another in a manner that maximizes breathability, while also reducing the risk of dental tools, debris, water, and/or saliva falling therein. This spacing may be measured by a distance 111 from a geometric center of a first perforation 110 to a geometric center of an immediately adjacent, second perforation 110—i.e., a center-to-center distance 111. As shown, a center-to-center distance 111a, 111b may be measured from a perforation 110 to any of its immediately adjacent perforations 110. Accordingly, the spacing of a perforation may be characterized by multiple center-to-center distances 111a, 111b.

In some embodiments, each of the plurality of perforations 100 comprises at least one center-to-center distance 111 ranging from 1 mm to 6 mm when elastic sheet 100 is in an unstretched and/or stretched state. In some embodiments, each center-to-center distance 111 of each of a plurality of perforations 110 ranges from 1 mm to 6 mm when elastic sheet 100 is in an unstretched and/or stretched state. In some embodiments, each center-to-center distance 111 of all of the plurality of perforations 110 in a group of perforations 110 ranges from 1 mm to 6 mm when elastic sheet 100 is in an unstretched and/or stretched state.

In some embodiments, each of the plurality of perforations 110 comprises at least one center-to-center distance 111 ranging from 1.6 mm to 2.4 mm when elastic sheet 100 is in an unstretched and/or stretched state. In some embodiments, each center-to-center distance 111 of each of a plurality of perforations ranges from 1.6 mm to 2.4 mm when elastic sheet 100 is in an unstretched and/or stretched state. In some embodiments, each center-to-center distance 111 of all of the plurality of perforations 110 in a group of perforations 110 ranges from 1.6 mm to 2.4 mm when elastic sheet 100 is in an unstretched and/or stretched state.

In some embodiments, each of the plurality of perforations 110 comprises at least one center-to-center distance 111 ranging from 2 mm to 3 mm when elastic sheet 100 is in an unstretched and/or stretched state. In some embodiments, each center-to-center distance 111 of each of a plurality of perforations 110 ranges from 2 mm to 3 mm when elastic sheet 100 is in an unstretched and/or stretched state. In some embodiments, each center-to-center distance 111 of all of the plurality of perforations 110 in a group of perforations 110 ranges from 2 mm to 3 mm when elastic sheet 100 is in an unstretched and/or stretched state.

In some embodiments, each of the plurality of perforations 110 comprises at least one center-to-center distance 111 ranging from 2.8 mm to 4.2 mm when elastic sheet 100 is in an unstretched and/or stretched state. In some embodiments, each center-to-center distance 111 of a of the plurality of perforations 110 ranges from 2.8 mm to 4.2 mm when elastic sheet 100 is in an unstretched and/or stretched state. In some embodiments, each center-to-center distance 111 of all of the plurality of perforations 110 in a group of perforations 110 ranges from 2.8 mm to 4.2 mm when elastic sheet 100 is in an unstretched and/or stretched state.

In some embodiments, each of the plurality of perforations 100 comprises at least one center-to-center distance 111 ranging from 4 mm to 6 mm when elastic sheet 100 is in an unstretched and/or stretched state. In some embodiments, each center-to-center distance 11 of each of a plurality of perforations 110 ranges from 4 mm to 6 mm when elastic sheet 100 is in an unstretched and/or stretched state. In some embodiments, each center-to-center distance 111 of all of the plurality of perforations 110 in a group of perforations 110 ranges from 4 mm to 6 mm when elastic sheet 100 is in an unstretched and/or stretched state.

As mentioned above, plurality of perforations 110 are configured to provide breathability to elastic sheet 100. To achieve sufficient breathability, the plurality of perforations 110 may comprise a targeted cumulative open surface area on elastic sheet 100. In some embodiments, the plurality of perforations 110 comprises a cumulative open surface area ranging from 20 mm² to 90 mm² when elastic sheet 100 is in an unstretched state. In some embodiments, plurality of perforations 110 comprises a cumulative open surface area ranging from 20 mm² to 90 mm² when elastic sheet 100 is in a stretched state. In some embodiments, the plurality of perforations 110 comprises a cumulative open surface area ranging from 20 mm² to 40 mm² when elastic sheet 100 is in an unstretched state. In some embodiments, the plurality of perforations 110 comprises a cumulative open surface area ranging from 20 mm² to 40 mm² when elastic sheet 100 is in a stretched state. In some embodiments, the plurality of perforations 110 comprises a cumulative open surface area ranging from 40 mm² to 90 mm² when elastic sheet 100 is in an unstretched state. In some embodiments, the plurality of perforations 110 comprises a cumulative open surface area ranging from 40 mm² to 90 mm² when elastic sheet 100 is in a stretched state. The cumulative open surface area for a group of perforations 110 is the sum of the size for each opening in the elastic sheet defined by the perforations 110.

As shown, perforations 110 on elastic sheet 100 may be positioned in a perforated region 140 comprising a plurality of perforations 110. In some embodiments, a perforated region 140 may comprise at least 50 perforations 110. In some embodiments, a perforated region 140 may comprise at least 60 perforations 110. In some embodiments, a perforated region 140 may comprise at least 70 perforations 110. In some embodiments, a perforated region 140 may comprise at least 90 perforations 110. In some embodiments, a perforated region 140 may comprise at least 120 perforations 110. In some embodiments, a perforated region 140 may comprise at least 150 perforations 110. In some embodiments, a perforated region 140 may comprise 50 to 190 perforations 110. In some embodiments, a perforated region 140 may comprise 60 to 190 perforations. In some embodiments, a perforated region 140 may comprise 70 to 190 perforations. In some embodiments, a perforated region 140 may comprises 80 to 190 perforations.

In some embodiments, a perimeter 141 of perforated region 140 is defined by an outermost perimeter set of perforations of plurality of perforations 110. As shown, for example in FIG. 1, in some embodiments, the perimeter 141 of perforated region 140 may be crescent-shaped when elastic sheet 100 is in an unstretched and/or stretched state. In some embodiments, the perimeter 141 of perforated region 140 may be circular, ovular, or polygonal when elastic sheet 100 is in an unstretched and/or stretched state. In some embodiments, perforations 110 may comprise concentric bands of perforations 110 arranged about a geometric center of perforated region 140 as described herein.

In some embodiments, the perimeter 141 of perforated region 140 may range from 105 mm to 180 mm when elastic sheet 100 is in an unstretched and/or stretched state. In some embodiments, the perimeter 141 of a perforated region 140 may range from 105 mm to 155 mm when elastic sheet 100 is in an unstretched and/or stretched state. In some embodiments, perimeter 141 may range from 120 mm to 180 mm when elastic sheet 100 is in an unstretched and/or stretched state. In some embodiments, perimeter 141 may range from 110 mm to 165 mm when elastic sheet 100 is in an unstretched and/or stretched state. In some embodiments, a maximum height 142 of the perimeter 141 of perforated region 140 may range from 32 mm to 48 mm when elastic sheet 100 is in an unstretched and/or stretched state. In some embodiments, a maximum width 143 of the perimeter 141 of perforated region 140 may range from 24 mm to 36 mm when elastic sheet 100 is in an unstretched and/or stretched state.

In some embodiments, the perimeter 141 of perforated region 140 may coincide with a perimeter of breathing portion 150. In some embodiments, a perforated region 140 may occupy the entirety of breathing portion 150 and may comprise a plurality of perforations 110 with any of the numbers, shapes, open surface areas, center-to-center distances, and/or orientations of perforations 110 discussed herein. In some embodiments, a perforated region 140 may occupy a surface area of at least 90% of the total surface area of breathing portion 150 and may comprise a plurality of perforations 110 with any of the numbers, shapes, open surface areas, center-to-center distances, and/or orientations of perforations 110 discussed herein. In some embodiments, a perforated region 140 may occupy a surface area of at least 75% of the total surface area of breathing portion 150 and may comprise a plurality of perforations 110 with any of the numbers, shapes, open surface areas, center-to-center distances, and/or orientations of perforations 110 discussed herein. In some embodiments, a perforated region 140 may occupy a surface area of at least 50% of the total surface area of breathing portion 150 and may comprise a plurality of perforations 110 with any of the numbers, shapes, open surface areas, center-to-center distances, and/or orientations of perforations 110 discussed herein.

In some embodiments, a perforated region 140 may comprise an open area ratio, the open area ratio being a sum of the open surface area of the perforations 110 bounded by the perimeter 141 of the perforated region 140 divided by a total surface area of perforated region 140. In some embodiments, the open area ratio of perforated region 140 ranges from 0.005 to 0.07 when elastic sheet 100 is in an unstretched and/or stretched state. In some embodiments, the open area ratio of perforated region 140 ranges from 0.03 to 0.07 when elastic sheet 100 is in an unstretched and/or stretched state. In some embodiments, the open area ratio of perforated region 140 ranges from 0.01 to 0.03 when elastic sheet 100 is in an unstretched and/or stretched state. In some embodiments, the open area ratio of perforated region 140 ranges from 0.02 to 0.04 when elastic sheet 100 is in an unstretched and/or stretched state. In some embodiments, the open area ratio of perforated region 140 ranges from 0.005 to 0.01 when elastic sheet 100 is in an unstretched and/or stretched state.

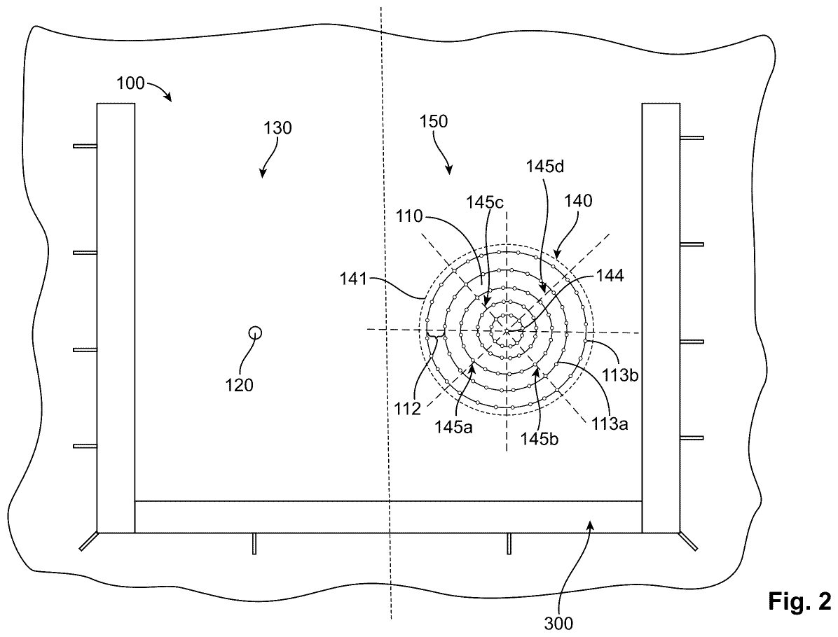

FIG. 2 shows an elastic sheet 100 according to some embodiments. As shown, elastic sheet 100 comprises a working portion 130, which may comprise opening 120, and breathing portion 150 comprising a perforated region 140 comprising plurality of perforations 110.

As shown, the perimeter 141 of perforated region 140 is circular when elastic sheet 100 is in an unstretched and/or stretched state. In some embodiments, perimeter 141 ranges from 120 mm to 180 mm. In some embodiments, perimeter 141 ranges from 110 mm to 165 mm.

As shown, in some embodiments, the plurality of perforations 110 may comprise concentric bands 113a, 113b of perforations arranged about a geometric center 144 of perforated region 140 when elastic sheet 100 is in an unstretched and/or stretched state. In such embodiments, the concentric bands 113a, 113b of perforations may be spaced from one another by distance 112. In some embodiments, each of the concentric bands 113a, 113b of perforations 110 may be spaced by distance 112 ranging from 3.2 mm to 4.8 mm when elastic sheet 100 is in an unstretched and/or stretched state. In some embodiments, each of the concentric bands 113a, 113b of perforations 100 may be spaced by distance 112 ranging from 2.8 mm to 4.2 mm when elastic sheet 100 is in an unstretched and/or stretched state.

In some embodiments, perforated region 140 may comprise quadrants 145a, 145b, 145c, 145d. In some embodiments, each of the quadrants 145a, 145b, 145c, 145d of perforated region 140 comprises at least 20 perforations. In some embodiments, each of the quadrants 145a, 145b, 145c, 145d of perforated region 140 comprises 30 to 45 perforations. In some embodiments, each of the quadrants 145a, 145b, 145c, 145d of perforated region 140 comprises 55 to 85 perforations.

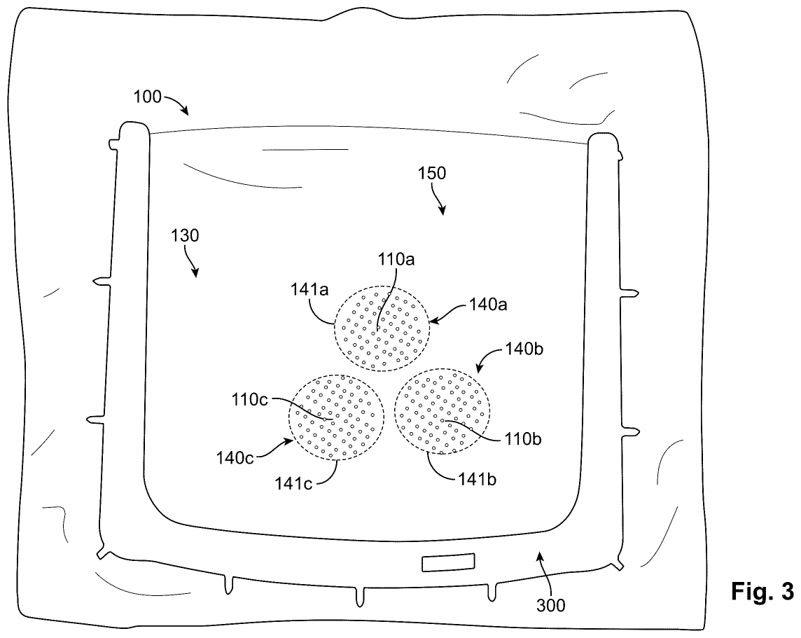

FIG. 3 shows an elastic sheet 100 comprising a plurality of separate perforated regions according to some embodiments. In such embodiments, each of the plurality of perforated regions 140a, 140b, 140c are located in the working portion 130. In some embodiments, elastic sheet 100 may comprise two, three, four, five, or six perforated regions. As shown, each of plurality of perforated regions 140a, 140b, 140c comprise subsets of plurality of perforations 110a, 110b, 110c. In some embodiments, each of the subsets of plurality of perforations 110a, 110b, 110c comprise at least 50 perforations. In some embodiments, each of the subsets of plurality of perforations 110a, 110b, 110c comprise at least 60 perforations. In some embodiments, each of the subsets of plurality of perforations 110a, 110b, 110c comprise 50 to 100 perforations 110. In some embodiments, each of the subsets of plurality of perforations 110a, 110b, 110c comprise 60 to 100 perforations 110.

In some embodiments, a total number of perforations 110 in the subsets of plurality of perforations 110a, 110b, 110c may be at least at least 100 perforations, at least 150 perforations 110, or at least 190 perforations. In some embodiments, a total number of perforations 110 in the subsets of plurality of perforations 110a, 110b, 110c may be from 100 to 250 perforations.

Each of the plurality of perforated regions 140a, 140b, 140c may comprise any of the features and/or combination of features discussed above for a perforated region 140. By way of example the perimeters 141a, 141b, 141c of plurality of perforated regions 140a, 140b, 140c may be circular when elastic sheet 100 is in an unstretched and/or stretched state. By way of another example, a perimeter 141a of a first perforated region 140a may be circular, while a perimeter 141b, 141c of a second and third perforated region 140b, 140c may be crescent-shaped when elastic sheet 100 is in an unstretched and/or stretched state. By way of yet another example, the perimeters 141a, 141b, 141c of the plurality of perforated regions 140a, 140b, 140c may comprise differing lengths. In another example, each of the plurality of perforated regions 140a, 140b, 140c may comprise different open surface area ratios.

Similarly, each subset of the plurality of perforations 110a, 110b, 110c may comprise any of the features and/or combinations of features discussed above for perforations 110. By way of example a first subset of the plurality of perforations 110a may comprise perforations 110 having a center-to-center distance 111 that is greater than the center-to-center distance 111 of the perforations of a second subset of the plurality of perforations 110b. By way of another example, each subset of the plurality of perforations 110a, 110b, 110c may comprise perforations 110 with differing open surface areas.

Those skilled in the art will appreciate that the above examples are non-limiting—and that each of the plurality of perforated regions 140a, 140b, 140c and each subset of the plurality of perforations 110a, 110b, 110c may comprise any of the features and/or combination of features discussed above in connection with FIGS. 1-2.

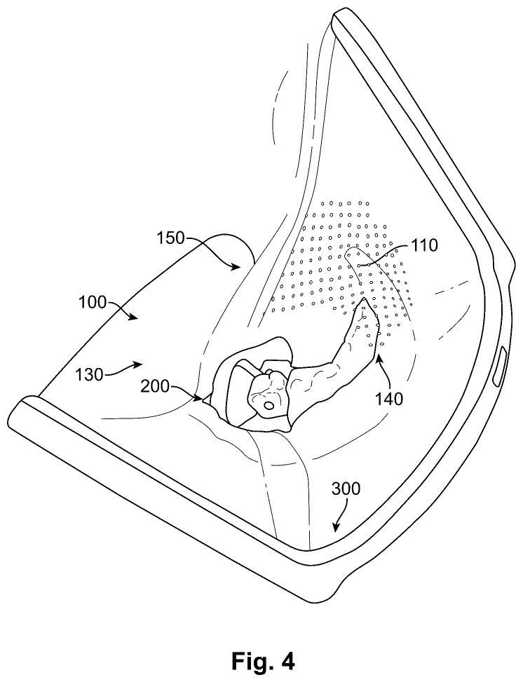

FIG. 4 shows elastic sheet 100 spread about a mouth of a patient. As shown, elastic sheet 100 is removably coupled to a tooth of the patient via clamp 200, which is accepted within opening 120 of working portion 130. Elastic sheet 100 is also stretched to a stretched state and spread about the mouth of the patient via frame for dentistry 300. As shown, elastic sheet 100 comprises breathing portion 150 comprising perforated region 140 comprising a plurality of perforations 110.

In some embodiments, rather than breathing portion 150 comprising a plurality of perforations 110, breathing portion 150 may comprise a stamp that marks an intended location of any features discussed with respect to FIGS. 1-4, and/or any combination thereof. In such embodiments, that the stamp functions as a template for where a user should perforate elastic sheet 100 with a plurality of perforations 110 as described herein. By way of example, the stamp may mark an intended location of each of the plurality of perforations 110 so that the user may perforated elastic sheet 100 with plurality of perforations 110, using the stamp as a template. By way of another example, the stamp may mark an intended location of perimeter 141 of perforated region 140 such that the user may perforate elastic sheet 100 with a custom orientation of plurality of perforations 110, using the stamp as a boundary for said custom orientation of plurality of perforations 110. In some embodiments, the stamp may be an ink stamp on a surface of the elastic sheet 100.

As mentioned above, in some embodiments, working portion 130 may not comprise an opening 120. In such embodiments, working portion 130 may comprise a stamp that marks an intended location of opening(s) 120, such that the stamp functions as a template configured to assist a user in making opening(s) 120 in elastic sheet 100.

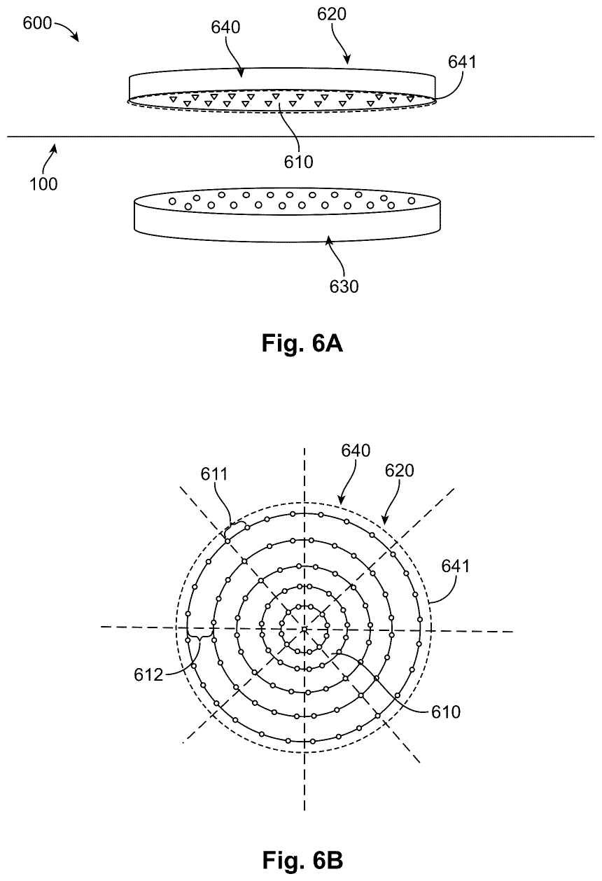

Embodiments of elastic sheet 100 comprising a stamp may also be used with a punch for perforating elastic sheet 100, as discussed with respect to FIGS. 6A-B below.

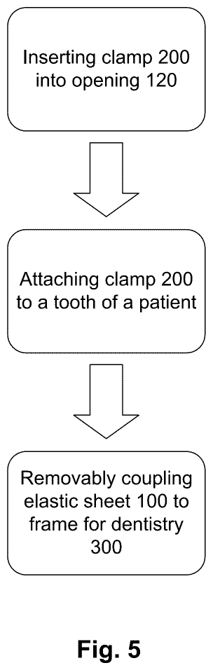

FIG. 5 shows a method for using elastic sheet 100 according to some embodiments. The method may comprise a step of inserting clamp 200 into opening 120 of working portion 130. In some embodiments, the step of inserting clamp 200 into opening 120 may be omitted when, e.g., opening 120 itself is to be removably coupled to a tooth of a patient. In some embodiments, a step of cutting opening 120 may precede the step of inserting clamp 200 into opening 120 when elastic sheet 100 does not comprise a pre-formed opening 120, as described above. Likewise, in some embodiments, the method of using elastic sheet 100 may comprise the step of cutting opening 120 when opening 120 itself is to be removably coupled to a tooth of a patient. In embodiments where clamp is inserted into the opening 120, the method may comprise the step of attaching clamp 200 to a tooth of patient.

The method further comprises the step of removably coupling elastic sheet 100 to frame for dentistry 300 such that elastic sheet 100 at least partially covers a mouth of the patient. After removably coupling elastic sheet 100 to frame for dentistry 300, a dental procedure can be performed while simultaneously allowing a patient to breathe comfortably and prevent foreign material, e.g., dental tools, debris, water, and/or salvia from falling into a patient's airway.

The foregoing steps may be completed in any logical order. By way of example, in some instances, clamp 200 may be attached to a tooth of a patient and, thereafter, opening 120 of elastic sheet 100 is coupled thereto. By way of another example, in some instances, elastic sheet 100 may be removably coupled to frame for dentistry 300 before opening 120 and/or clamp 200 are affixed to a tooth of a patient.

In some embodiments, the plurality of perforations 110 can be formed in elastic sheet 100 with a punch. FIG. 6A shows a punch 600 for perforating an elastic sheet 100 according to some embodiments. Punch 600 comprises a plurality of protrusions 610 configured to perforate elastic sheet 100 with the plurality of perforations 110. FIG. 6B shows a bottom-up view of the perforating member 620.

In some embodiments, punch 600 comprises perforating member 620 having plurality of protrusions 610 and base 630 configured to receive plurality of protrusions 610. An elastic sheet 100 may be placed between perforating member 620 and base 630 such that, as plurality of protrusions 610 of perforating member 620 are received by base 630, elastic sheet 100 is perforated with plurality of perforations 110.

Perforating member 620 comprises a perforating region 640 having plurality of protrusions 610. In some embodiments, a perimeter 641 of perforating region 640 is defined by an outmost perimeter set of protrusions of plurality of protrusions 610.

As shown in FIGS. 6A-B, perforating member 620 of punch 600 comprises features that correspond to features of elastic sheet 100 as described above. By way of example, each of the plurality of protrusions may comprise a center-to-center distance 611 that corresponds to center-to-center distance 111 of each of the plurality of perforations 110 of elastic sheet 100 perforated by punch 600. By way of another example, perimeter 641 of perforating region 640 may correspond to perimeter 141 of perforated region 140 of elastic sheet 100 perforated by punch 600. In yet another example, concentric bands of protrusions 610 may be spaced from one another by distance 612 that corresponds to distance 112 of concentric bands of perforations 110 of elastic sheet 100 perforated by punch 600.

Likewise, any of the features of plurality of perforations 110, perforated region 140, and perimeter 141 of perforated region 140 of elastic sheet 100 may correspond to a feature of plurality of protrusions 610, perforating region 640, and perimeter 641 of perforating region 640, respectively. By way of example, the plurality of protrusions 610 may be configured to perforate elastic sheet 100 with any of the numbers, shapes, open surface areas, center-to-center distances, cumulative open surfaces areas, or orientations of plurality of perforations 110 discussed above. By way of another example, perforating region 640 may comprise a density of plurality of protrusions 610 configured to provide any of the open surface area ratio of perforated region 140 discussed above. In yet another example, punch 600 may comprise a plurality of perforating regions configured to perforate elastic sheet 100 with any of the numbers, shapes, sizes, or orientations of plurality of perforated regions 140a, 140b, 140c discussed above. As yet another example, perimeter 641 of perforating region 640 may be configured to perforate elastic sheet 100 with any of the shapes, sizes, or orientations of the perimeter 141 of perforated region 140 discussed above.

In some embodiments, where elastic sheet 100 comprises a stamp marking an intended location of any of the features discussed with respect to FIGS. 1-4, and/or any combination thereof, the stamp may serve as a template to guide the placement of a corresponding feature of punch 600. By way of example, a stamp marking an intended location of perimeter 141 of perforated region 140 may serve as a template for guiding the placement of perimeter 641 of perforating region 640 of punch 600. Similarly, by way of another example, a stamp marking an intended location of plurality of perforations 110 may serve as a template for guiding the placement of plurality of protrusions 610 of punch 600.

In some embodiments, punch 600 can be incorporated into or comprise a handheld tool configured to assist a user in utilizing punch 600. By way of example, punch 600 may be incorporated into or comprise a handheld tool configured such that, as the user squeezes a handle of the handheld perforating tool, plurality of protrusions 610 of perforating member 620 are received by base 630—thereby perforating elastic sheet 100 placed therebetween with plurality of perforations 110. In some embodiments, the handheld tool may resemble a hole-punch. In some embodiments, the handheld tool may resemble a embosser such that, as the user presses down on a lever of the handheld tool, plurality of protrusions 610 of perforating member 620 are received by base 630 and perforate elastic sheet 100. In another example, punch 600 may be incorporated into or comprise a handheld tool that comprises a rolling mechanism having plurality of protrusions 610. In such example, as the user rolls the rolling mechanism of the handheld tool over elastic sheet 100, plurality of protrusions are received by base 630 and perforate elastic sheet 100. In such example, base 630 may comprise a perforable material, such as, e.g., foam, for receiving plurality of protrusions 610.

Those skilled in the art will appreciate that the above examples are non-limiting—and that punch 600 can be incorporated into or comprise any handheld tool configured to assist a user in utilizing punch 600.

In some embodiments, punch 600 can be incorporated into or comprise automated machinery for automatically perforating elastic sheet 100. By way of example, punch 600 can be incorporated into or comprise an automated die configured such that, upon instruction by a user, plurality of protrusions of perforating member 620 are automatically received by base 630—thereby perforating elastic sheet 100 placed therebetween with plurality of perforations 110. In some embodiments, the automated machinery for automatically perforating elastic sheet 100 may be a component of an automated production line.

Those skilled in the art will appreciate that this example is not limiting—and that punch 600 can be incorporated into or comprise any automated machinery configured to automatically perforate elastic sheet 100.

The foregoing description of the specific embodiments will so fully reveal the general nature of the disclosure such that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance present herein. It is to be understood that the phraseology of terminology herein is for the purpose of description and not of limitation, such that the terminology or phraseology of the present description is to be interpreted by the skilled in light of the teaching and guidance.

The breadth and scope of the present disclosure should not be limited by any of the above-described exemplary embodiments, but should be defined only in accordance with the following claims and their equivalents.

What is claimed is:

1. An elastic sheet for dentistry, the elastic sheet comprising:
a working portion; and
a breathing portion comprising a perforated region, the perforated region comprising a plurality of perforations,
wherein each of the plurality of perforations comprises an open surface area ranging from 0.12 mm² to 1.2 mm² when the elastic sheet is in an unstretched state,
wherein the plurality of perforations comprises at least 50 perforations, and
wherein the elastic sheet is sized to be removably coupled to a frame for dentistry.

2. The elastic sheet of claim 1, wherein the breathing portion comprises a plurality of perforated regions, and
wherein each of the plurality of perforated regions comprises a subset of the plurality of perforations.

3. The elastic sheet of claim 2, wherein each of the subsets of the plurality of perforations comprises at least 50 perforations.

4. The elastic sheet of claim 1, wherein a surface area of the breathing portion ranges from 40% to 60% of a total surface area of the elastic sheet.

5. The elastic sheet of claim 1, wherein a center-to-center distance of each of the plurality of perforations ranges from 1 mm to 6 mm when the elastic sheet is in the unstretched state, the center-to-center distance being a distance measured from a first geometric center of a first perforation to a second geometric center of a second perforation, the second perforation being immediately adjacent to the first perforation.

6. The elastic sheet of claim 5, wherein a center-to-center distance of each of the plurality of perforations ranges from 2.8 mm to 4.2 mm when the elastic sheet is in the unstretched state.

7. The elastic sheet of claim 1, wherein the plurality of perforations comprises a cumulative open surface area ranging from 20 mm² to 90 mm² when the elastic sheet is in the unstretched state.

8. The elastic sheet of claim 1, wherein the plurality of perforations comprises 80 to 190 perforations.

9. The elastic sheet of claim 1, wherein the perforated region comprises four quadrants and each of the four quadrants comprises at least 20 perforations.

10. The elastic sheet of claim 1, wherein the plurality of perforations comprises concentric bands of perforations arranged about a geometric center of the perforated region.

11. The elastic sheet of claim 1, wherein a perimeter of the perforated region is defined by an outermost perimeter set of perforations of the plurality of perforations, and
wherein an open area ratio of the perforated region ranges from 0.005 to 0.07 when the elastic sheet is in the unstretched state, the open area ratio being a sum of the open surface area of the perforations divided by a total surface area of the perforated region.

12. The elastic sheet of claim 1, wherein each of the plurality of perforations comprises an open surface area ranging from 0.12 mm² to 0.29 mm² when the elastic sheet is in the unstretched state.

13. The elastic sheet of claim 1, wherein the working portion comprises an opening configured to accept a tooth of a patient therein.

14. The elastic sheet of claim 1, wherein a perimeter of the perforated region is defined by an outermost perimeter set of perforations of the plurality of perforations, and
wherein the perimeter ranges from 105 mm to 155 mm when the elastic sheet is in the unstretched state.

15. A method of using the elastic sheet of claim 1, the method comprising the steps of:
inserting a clamp into an opening in the working portion of the elastic sheet;
attaching the clamp to a tooth of a patient; and
removably coupling the elastic sheet to the frame for dentistry,
wherein the elastic sheet at least partially covers a mouth of the patient when removably coupled to the frame for dentistry.

16. The method of claim 15, wherein the elastic sheet is in a stretched state when removably coupled to the frame for dentistry and wherein each of the plurality of perforations comprises an open surface area ranging from 0.12 mm² to 1.2 mm² when the elastic sheet is in the stretched state.

17. The method of claim 15, wherein the plurality of perforations comprises a cumulative open surface area ranging from 20 mm² to 90 mm² when the elastic sheet is in the stretched state.

18. A punch for perforating an elastic sheet to be used for dentistry, the punch comprising:
a perforating member comprising a perforating region, the perforating region comprising a plurality of protrusions; and
a base configured to receive the plurality of protrusions,
wherein the punch is configured to perforate an elastic sheet placed between the base and the perforating member with a plurality of perforations, each of the plurality of perforations comprising an open surface area ranging from 0.12 mm² to 1.2 mm², and
wherein the plurality of protrusions comprises at least 50 protrusions.

19. The punch of claim 18, wherein the plurality of protrusions comprises 80 to 190 protrusions.

20. The punch of claim 18, wherein a center-to-center distance of each of the plurality of protrusions ranges from 1 mm to 6 mm, the center-to-center distance being a distance measured from a first geometric center of a first protrusion to a second geometric center of a second protrusion, the second protrusion being immediately adjacent to the first protrusion.
